(19) United States
(12) Patent Application Publication
(10) Pub. No.: US 2008/0087581 A1
(43) Pub. Date: Apr. 17, 2008

(54) Device For Separating Granular Material

(75) Inventors: Erika Eisenhut, Oberuzwil (CH); Marcel Linder, Bischofszell (CH)

Correspondence Address: BUCHANAN, INGERSOLL & ROONEY PC, POST OFFICE BOX 1404, ALEXANDRIA, VA, 22313-1404, US

(73) Assignee: BUHLER AG, Uzwil (CH)

(21) Appl. No.: 11/665,933

(22) PCT Filed: Sep. 8, 2005
(86) PCT No.: PCT/CH05/00535

§ 371 Date: Oct. 1, 2007

(30) Foreign Application Priority Data
Nov. 9, 2004 (DE) 10 2004 054 275.9

(51) Int. Cl. B07B 4/08

(52) U.S. Cl. 209/318

(57) ABSTRACT

The invention relates to a device for separating granular material, especially a light grain selector for cereal crops or similar, comprising a sieve cage with at least two sieve layers that are provided with perforated plates. The sieve layers can be penetrated by air from below. The sieve cage is equipped with at least one oscillating drive unit while each sieve layer (2 to 5) encompasses a final separation zone.

The invention relates to a device for separating granular material, especially a light grain sorter, in particular for separating lighter constituents of granular material mixtures.

Machines or separators for separating and/or cleaning granular material mixtures are known in the art. For example, there are rock sorters or machines for separating heavy or light fractions.

They are used both for pre-cleaning in the silo, as well as for cleaning grain. The fractions are separated through vibration and exposure to air streams.

Each cleaning machine initially had specific functions, which resulted in a plurality of individual machines. Therefore, machines that combined two or three operations were developed. For example, WO 85/05049 describes a machine that is both rock sorter and concentrator. The used air stream is used both for sorting rocks and separating heavy from light product. The air streams through a perforated plate from below and the grain located thereon, causing stratification by specific weight, with the light material rising to the top. In a second screen half, the product can pass through the holes in the perforated plate. This heavy product gets onto the rock sorter. In order to obtain a minimal product layer for sorting purposes, the width of the screen plate is reduced in the drop zone in the outlet direction. The light product gets into the outlet.

Another combined machine is described in WO 88/04204, in which three screen layers are arranged in the upper region. As a result, coarse contaminants can be ejected in the first screen, while the fines, e.g., sand, are removed on the underlying screens. The grain then gets onto a fourth screen, where it is exposed to a stream of air, and a separation into light and heavy product takes place. The heavy product with filler gets onto the lowermost screen level, where the filler, e.g., comprised of stones or glass, is sorted out. The light product is relayed into an aspiration channel to separate out the light fraction.

It is also known for these machines to recycle the used air to keep down the demand for fresh air.

The object of the invention is to develop a device for separating out granular material, in particular one that enables the separation of product from filler that is lighter than normal cereal grains. In particular, this is intended to also reliably separate out mycotoxin-containing or similarly afflicted light grains or the like. The object is achieved with the features in the claim. Advantageous embodiments are disclosed in the subclaims.

In conjunction with a newly discovered type of air circulation and displacement in the final separation zone, a final separation between heavy and light product over each screen layer is possible on screen decks or screen plates. The heavy product on the screen decks floats up, and the lighter product descends. As a result of this stratification, the lighter product floats on the heavier product, and a final separation zone ensures that the lighter product cannot get into the outlet for the accepted product. The additional countercurrent stream of air that passes through the product from below blows the light product downward.

The screen plate of the lowermost screen layer is adjustable, in particular slidable and tiltable (independently of the remaining screen box, i.e., independently of the upper, preferably 3 screen layers), thereby creating a uniform air stream without swirls, and achieving a division into light product and rejects. The final separation devices are fixed in place. A portion of the air stream is relayed directly through the product to meter the countercurrent, which also enables a fine-tuning of the final separation zone. The rough setting of the air stream is preferably accomplished by changing the hole or slit size of the screen plate in the final separation device.

This tangibly improves and simplifies sorting quality.

The invention will be described in greater detail below in an exemplary embodiment based on a drawing. The drawing shows:

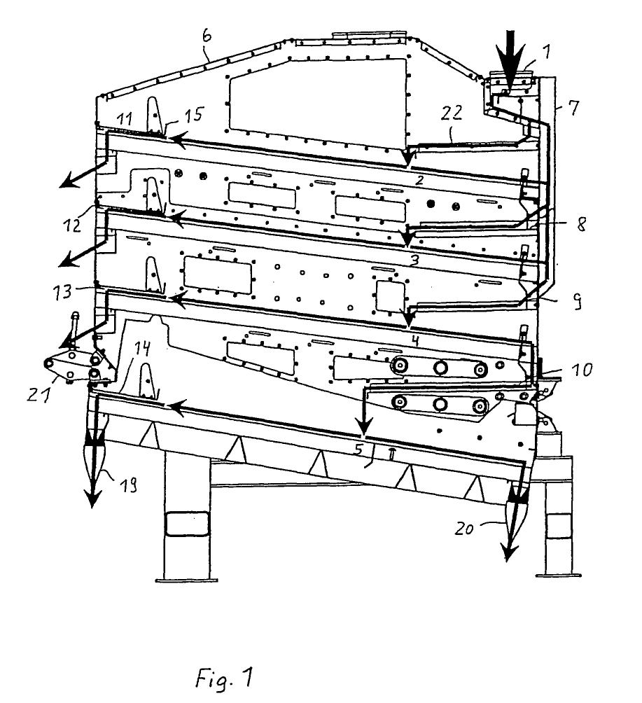

FIG. 1: A side view of a light grain sorter.

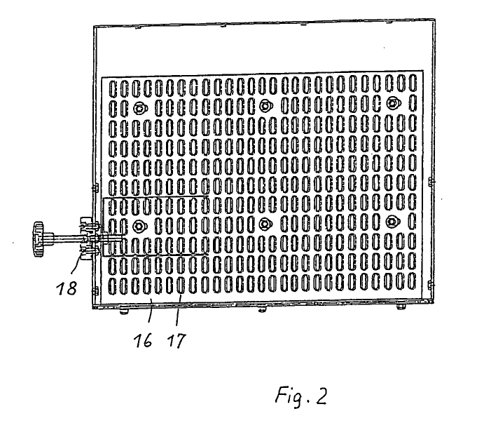

FIG. 2: A screen plate of a final separation zone, top view.

The device, a light grain sorter, has an inlet 1 of the screen box 5 for the granular material or raw product, wherein the feeding process can be controlled by means of a slider (not shown).

Situated under the inlet 1 is a product divider 7, which distributes the incoming raw product on the two upper screen layers 2, 3, preferably in a uniform manner by means of the feedback plate 22 or 8. Other such feedback plates 8, 9 and 10 are also situated in front of or above the screen layers 2, 4, 5.

Final separation zones or final separation devices 11, 12, 13, 14 are arranged at the upper end of the inclined screen layers 2, 3, 4, 5, and each have an deflector 15 for emerging light product, along with an adjustable perforated plate 16, wherein the open surface of the slits 17 can be varied by means of an adjusting device 18. To this end, a counter-plate is shifted parallel to the perforated plate 16. As a result, the counter-air stream can be regulated. The respective heavier product on the screen layers sinks down to the respective screen plate, and is conveyed to the upper end with the final separation devices 11-14 by the oscillating motion of the vibration drive (not marked).

No product drops through the screen plates of the screen layers 2-5. The counter-stream of air penetrating the screen layers 2-5 from below blows the respective lighter product downward. The heavier product is rejected through outlets (not marked) after the respective final separation device 11-14, e.g., one heavy product after final separation devices 11 and 12, and a mixed product after the final separation device 13. After the final separation device 14, a corresponding light product gets into an outlet 19.

The lighter product of the two upper screen layers 11 and 12 gets onto the screen layer 4 via the product divider 9 as a mixed product for gleaning purposes, and the light product formed there gets onto the lowermost screen layer 5 via the product divider 10 for gleaning purposes. The light scrap gets into the outlet 20. On the lowermost screen layer 5, the final separation device 14 prevents the scrap from exiting through the outlet 19 with the lighter product.

The inclination of the lowermost screen layer 5 can be adjusted by means of a regulator 21, so as to be able to influence product separation.

### REFERENCE NUMBERS

1 Inlet

2 Screen layer

3 Screen layer

4 Screen layer

5 Screen layer

6 Screen box

7 Product divider

8 Feedback plate

9 Feedback plate

10 Feedback plate

11 Final separation device

12 Final separation device

13 Final separation device

14 Final separation device

15 Deflector

16 Screen plate

17 Slit hole

18 Adjusting device

19 Outlet

20 Outlet

21 Regulator

22 Feedback plate

1. A device for separating granular material, which has a screen box with at least two screen layers with screen plates, wherein air can be passed through the screen layers from below, and the screen box is provided with at least one oscillating drive, and wherein each screen layer has a final separation zone or final separation device.

2. The device according to claim 1, wherein screen plates of the final separation devices are provided with openings, the size of which can be varied.

3. The device according to claim 1, wherein the inclination of the lowermost screen layer is variable.

4. The device according to claim 2, wherein the inclination of the lowermost screen layer is variable.

5. A light grain sorter for separating granular material, comprising:
a screen box provided with at least one oscillating drive, and
at least two screen layers with screen plates, wherein the screen layers are open to passage of air, and wherein each screen layer has a final separation zone or final separation device.
